(19) United States
(12) Patent Application Publication
(10) Pub. No.: US 2009/0123294 A1
(43) Pub. Date: May 14, 2009

(54) FUEL CELL WITH TEMPERATURE SENSOR DEVICE

(76) Inventors: MING-YAO DONG, Chupei (TW); Yung-Lieh Chien, Chupei (TW)

Correspondence Address: G. LINK CO., LTD., 3500 BELL ROAD, MINOOKA, IL, 60447, US

(21) Appl. No.: 12/013,456

(22) Filed: Jan. 13, 2008

(30) Foreign Application Priority Data
Nov. 12, 2007 (TW) 096219087

(51) Int. Cl. F04B 49/00; G01K 7/16; G01K 1/00

(52) U.S. Cl. 417/32; 374/185; 374/141; 374/E01.001; 374/E07.018

(57) ABSTRACT

The present invention relates to a fuel cell with temperature sensor device, characterized in which the membrane electrode assembly of the fuel cell is installed on a circuit board where the circuit board comprises a temperature sensor module having resistance property. The temperature sensor module is installed on the circuit board or a heat sink where the resistance of the temperature sensor module is used to determine the temperature surrounding the temperature sensor module.

### FIELD OF THE INVENTION

The present invention relates to a fuel cell with temperature sensor device, particularly a kind of fuel cell added with temperature measuring and temperature compensation function.

### BACKGROUND OF THE INVENTION

In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. While technological advances have rendered fuel cells more efficient, more problems are surfacing.

One of the problems derived is temperature change in the fuel cell. The power generation device in fuel cells comprises a plurality of circuit boards arranged in stack. After the power generation device undergoes chemical reaction, heat is generated, which, if not discharged from the power generation device, tends to raise the surrounding temperature and short-circuit the circuit boards or other electronic components. Thus power generation device of the fuel cells is typically installed with a heat sink to expel the heat energy generated in the process of chemical reaction to make sure the temperature of the fuel cell stabilizes below an upper range value. In the conventional design, the approximate overall temperature of the fuel cell can be measured, but it is not known whether the temperature of the power generation device stays within a set range.

In light of the drawbacks of conventional fuel cells, the inventor aims to develop a product that meets the current needs.

### SUMMARY OF THE INVENTION

The object of the invention is to provide a fuel cell with temperature sensor device characterized by arranging an element with equivalent resistance on a circuit board or a heat sink to detect the change of resistance value so as to determine temperature change.

The invention relates to a fuel cell with temperature sensor device, characterized in which the membrane electrode assembly of the fuel cell is installed on a circuit board where the circuit board comprises a temperature sensor module having the characteristics of resistor. The temperature sensor module is installed on the circuit board or a heat sink where the resistance of the temperature sensor module is used to determine the temperature surrounding the temperature sensor module.

The objects, features and effects of the invention are described in detail below with embodiments in reference to the accompanying drawings.

### BRIEF DESCRIPTION OF THE DRAWINGS

FIG. 1 is a perspective view of a single circuit board according to the invention;

FIG. 2 is a perspective view of a plurality of circuit boards in assembly according to the invention;

FIG. 3 is a side view of FIG. 2;

FIG. 4 is a perspective view of a third embodiment of the invention;

FIG. 5 is a side view of FIG. 4;

FIG. 6 is a perspective view of a fourth embodiment of the invention, and

FIG. 7 is a side view of FIG. 6.

### DETAILED DESCRIPTION OF THE INVENTION

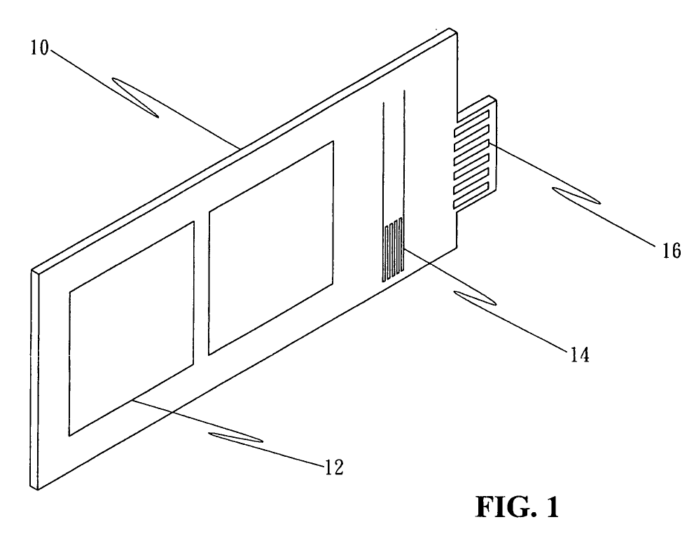

FIG. 1 is a perspective view of a first embodiment of the invention. The fuel cell with temperature sensor device according to the invention comprises a circuit board (10), at least a membrane electrode assembly (12) and a temperature sensor module (14) installed on the circuit board (10). The circuit board (10) is a common circuit board. The membrane electrode assembly (12) is the core power generation component of the fuel cell and a polymer membrane coated with platinum (Pt)-containing catalyst on the two side surfaces to form anode and cathode. The anode side is in contact with the hydrogen-containing fuel, while the cathode side is in contact with oxygen in the air. The membrane electrode assembly (12) undergoes chemical reaction under the action of catalyst and directly generates power for output. The membrane electrode assembly (12) is installed on the circuit board (10). On the left and right sides of the membrane electrode assembly (12) there is each provided a porous electrically conductive net as the power collector network for power output. The temperature sensor module (14) is made of conductive metal material to form an electrical construction with resistance effect and disposed on the circuit board (10).

The equivalent resistor in the temperature sensor module (14) can be a conductive line made of metallic material, such as aluminum, gold or copper, or a high-resistance circuit made of metallic material, such as nickel or chromium. Take the example of conductive line, the temperature sensor module (14) is made of common printed circuit board or formed by etching that endows the temperature sensor module (14) considerable resistance property. Based on the interdependence between the resistance of its conductive line and temperature, the temperature sensor module (14) obtains the temperature surrounding it by sensing the resistance of the conductive line. In addition, higher resistance of the temperature sensor module (14) can enhance the resolution of temperature sensing. Thus, the conductive line of the temperature sensor module (14) can be disposed on the circuit board (10) in a winding manner to extend its length.

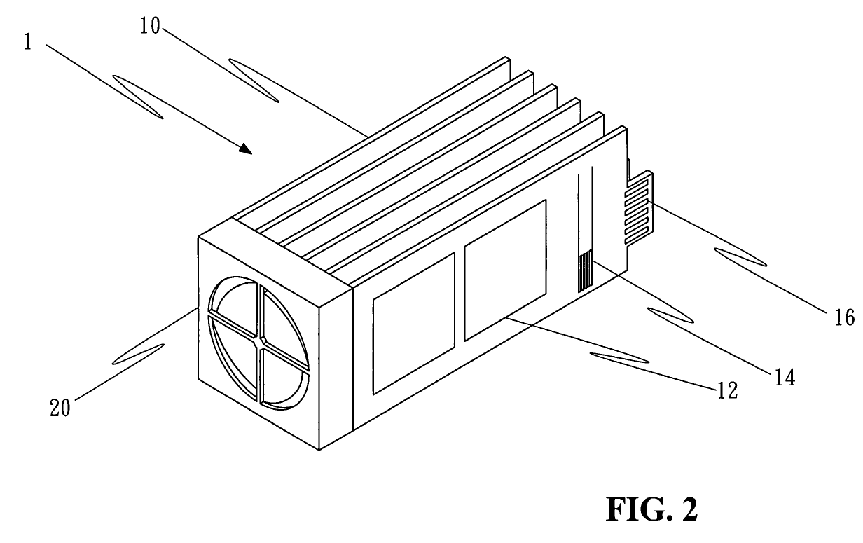

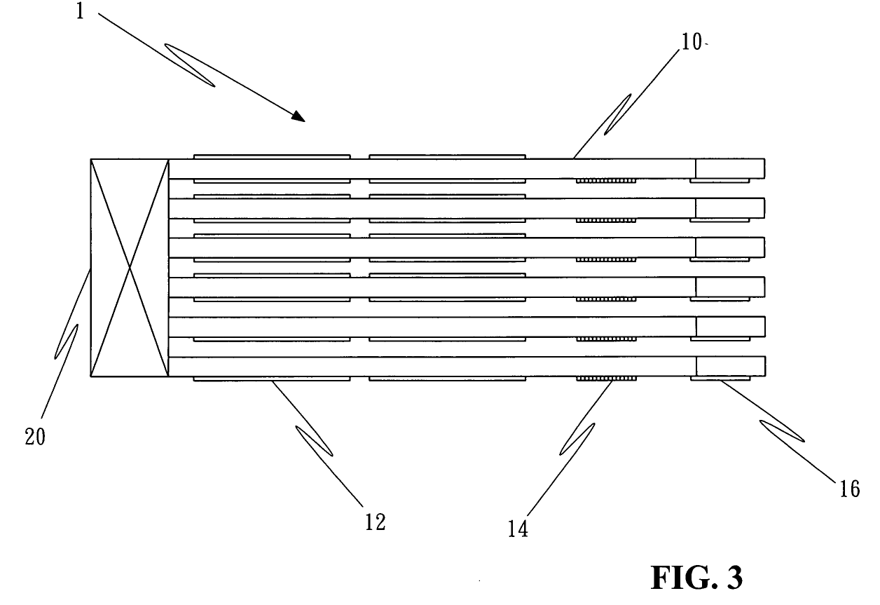

FIG. 2 is a perspective view of a second embodiment of the invention and FIG. 3 is a side view of FIG. 2. As shown, the fuel cell with temperature sensor device of the invention further comprises a plurality of circuit boards (10) to form a power generation structure (1). The plurality of circuit boards (10) are parallel to each other and arranged in alternative stack to form the power generation structure (1), and a heat sink (20) is disposed at one end of the power generation structure (1) to provide active heat dissipation.

One end of the circuit broad (10) can be extended with a connector (16). The connector (16) can transmit the signal of resistance change sent out by the temperature sensor module (14). In the case where the heat sink (20) is a fan, an electric signal on the resistance of the temperature sensor module (14) as measured or processed is sent to the heat sink (20) via the connector (16). The heat sink (20) installed on one side of the circuit board (10) will adjust its fan speed based on the electric signal received to keep the overall temperature within a range.

The electric signal on the resistance of the temperature sensor module (14) can also directly regulate the fan speed of the heat sink (20) through a common electric loop, thereby regulating the temperature of the power generation structure (1).

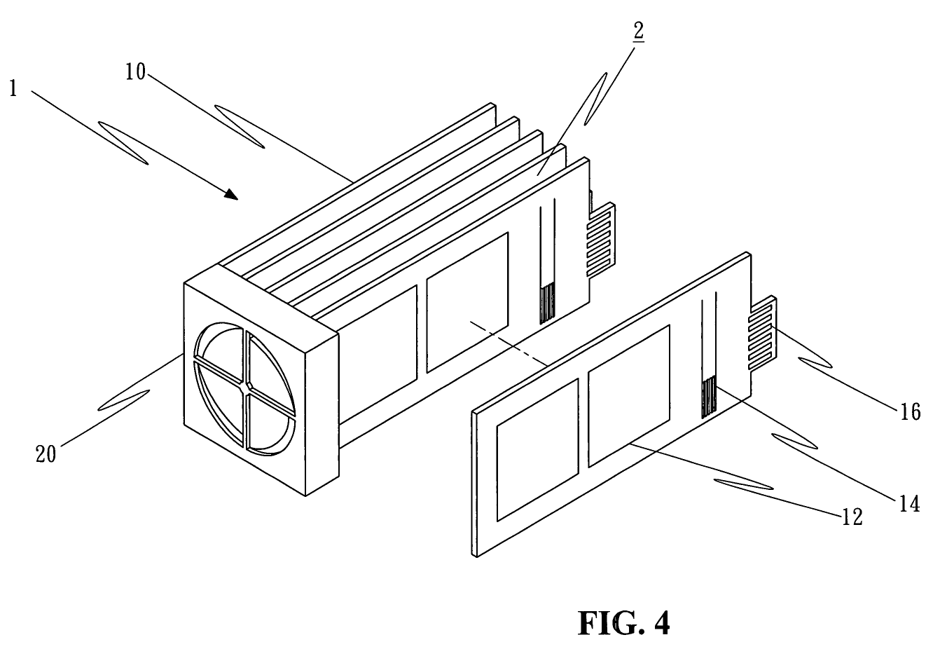

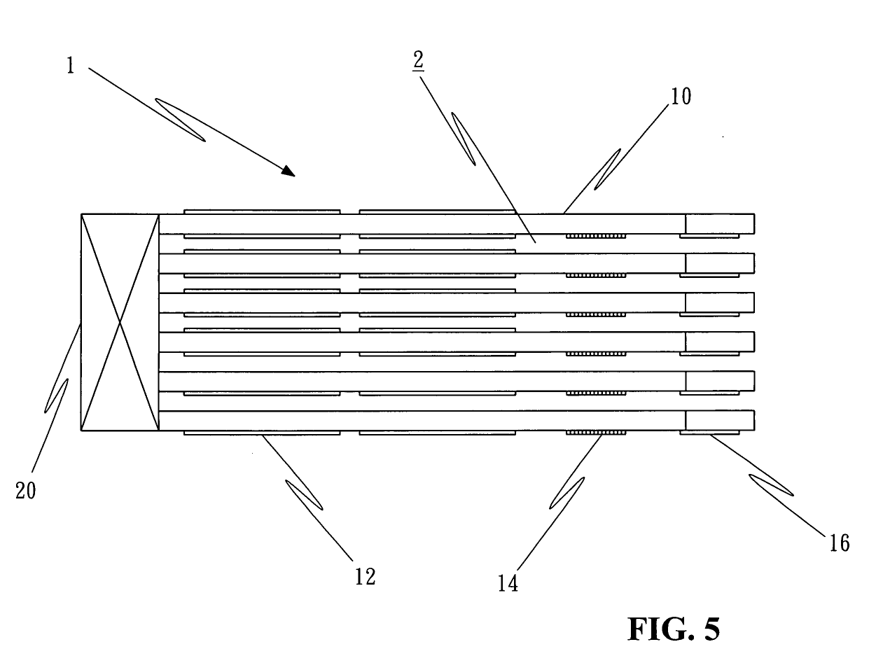

Referring to FIGS. 4 and 5, FIG. 4 is a perspective view of a third embodiment of the invention; FIG. 5 is a side view of FIG. 4. The fuel cell with a temperature sensor device according to the invention comprises a circuit board (10) and at least a membrane electrode assembly (12) installed on the circuit board (10). The circuit board (10) is a common circuit board. The circuit boards (10) are parallel to each other and arranged in alternate stack to form a power generation structure (1). An airflow path (2) is formed between the circuit boards (10), and a heat sink (20) disposed at one end of the power generation structure (1) enables the gas in the airflow path (2) to move. A temperature sensor module (14) can be installed between the airflow paths (2). The temperature sensor module (14) is made of conductive metal material to form an electrical construction with resistance effect and disposed on the circuit board (10). The membrane electrode assembly (12) is the core power generation component of the fuel cell and a polymer membrane coated with platinum (Pt)-containing catalyst on the two side surfaces to form anode and cathode. The anode side is in contact with the hydrogen-containing fuel, while the cathode side is in contact with oxygen in the air. The membrane electrode assembly (12) undergoes chemical reaction under the action of catalyst and directly generates power for output. The membrane electrode assembly (12) is installed on the circuit board (10). On the left and right sides of the membrane electrode assembly (12) there is each provided a porous electrically conductive net as the power collector network for power output.

The equivalent resistor in the temperature sensor module (14) can be a conductive line made of metallic material, such as aluminum, gold or copper, or a high-resistance circuit made of metallic material, such as nickel or chromium. Take the example of conductive line, the temperature sensor module (14) is made of common printed circuit board or formed by etching that endows the temperature sensor module (14) considerable resistance property. Based on the interdependence between the resistance of its conductive line and temperature, the temperature sensor module (14) obtains the temperature surrounding it by sensing the resistance of the conductive line. In addition, higher resistance of the temperature sensor module (14) can enhance the resolution of temperature sensing. Thus, the conductive line of the temperature sensor module (14) can be disposed on the circuit board (10) in a winding manner to extend its length.

One end of the circuit broad (10) can be extended with a connector (16). The connector (16) can transmit the signal of resistance change sent out by the temperature sensor module (14). In the case where the heat sink (20) is a fan, an electric signal on the resistance of the temperature sensor module (14) as measured or processed is sent to the heat sink (20) via the connector (16). The heat sink (20) installed on one side of the circuit board (10) will adjust its fan speed based on the electric signal received to keep the overall temperature within a range.

The electric signal on the resistance of the temperature sensor module (14) can also directly regulate the fan speed of the heat sink (20) through a common electric loop, thereby regulating the temperature of the power generation structure (1).

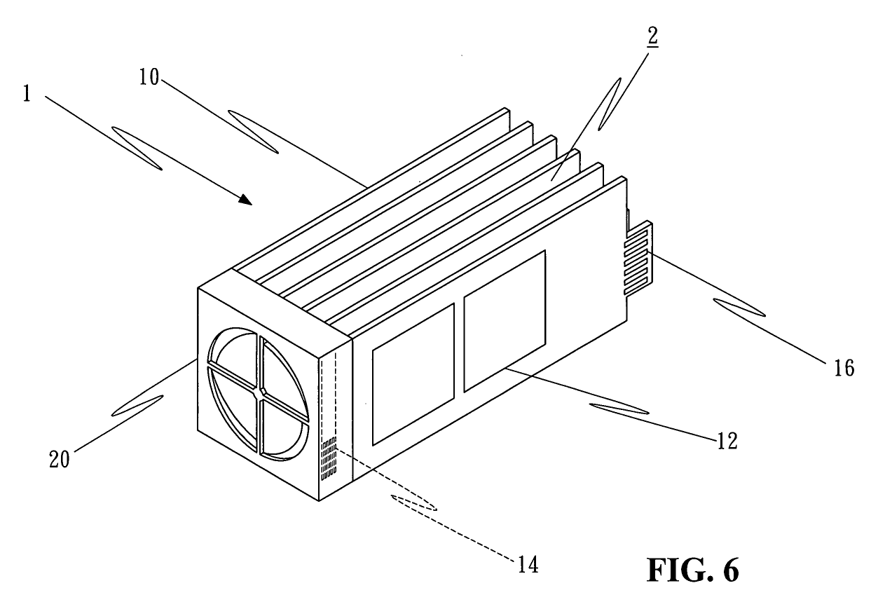

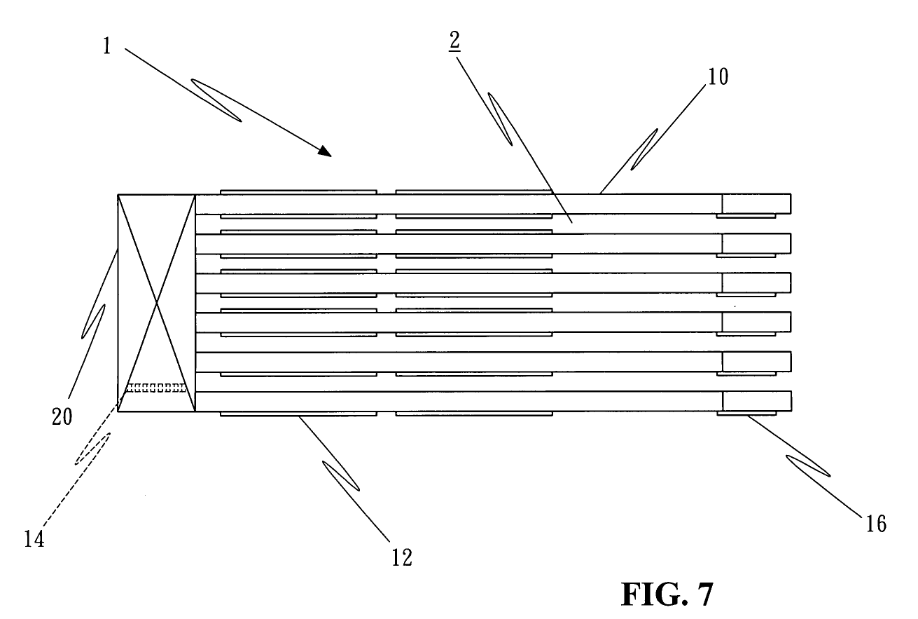

Referring to FIGS. 6 and 7, FIG. 6 is a perspective view of a fourth embodiment of the invention; FIG. 7 is a side view of FIG. 6. As shown, the fuel cell with a temperature sensor device according to the invention comprises a circuit board (10) and at least a membrane electrode assembly (12) installed on the circuit board (10). The circuit board (10) is a common circuit board. The circuit boards (10) are parallel to each other and arranged in alternate stack to form a power generation structure (1). An airflow path (2) is formed between the circuit boards (10), and a heat sink (20) disposed at one end of the power generation structure (1) enables the gas in the airflow path (2) to move. A temperature sensor module (14) can be installed between the airflow paths (2). The temperature sensor module (14) is made of conductive metal material to form an electrical construction with resistance effect and disposed on the heat sink (20). The membrane electrode assembly (12) is the core power generation component of the fuel cell and a polymer membrane coated with platinum (Pt)-containing catalyst on the two side surfaces to form anode and cathode. The anode side is in contact with the hydrogen-containing fuel, while the cathode side is in contact with oxygen in the air. The membrane electrode assembly (12) undergoes chemical reaction under the action of catalyst and directly generates power for output. The membrane electrode assembly (12) is installed on the circuit board (10). On the left and right sides of the membrane electrode assembly (12) there is each provided a porous electrically conductive net as the power collector network for power output.

The equivalent resistor in the temperature sensor module (14) can be a conductive line made of metallic material, such as aluminum, gold or copper, or a high-resistance circuit made of metallic material, such as nickel or chromium. Based on the interdependence between the resistance of its conductive line and temperature, the temperature sensor module (14) obtains the temperature surrounding it by sensing the resistance of the conductive line. In addition, higher resistance of the temperature sensor module (14) can enhance the resolution of temperature sensing. Thus, the conductive line of the temperature sensor module (14) can be disposed on the circuit board (10) in a winding manner to extend its length.

One end of the circuit broad (10) can be extended with a connector (16). The connector (16) can transmit the signal of resistance change sent out by the temperature sensor module (14). In the case where the heat sink (20) is a fan, an electric signal on the resistance of the temperature sensor module (14) as measured or processed is sent to the heat sink (20) via the connector (16). The heat sink (20) installed on one side of the circuit board (10) will adjust its fan speed based on the electric signal received to keep the overall temperature within a range.

The electric signal on the resistance of the temperature sensor module (14) can also directly regulate the fan speed of the heat sink (20) through a common electric loop, thereby regulating the temperature of the power generation structure (1).

The fuel cell with temperature sensor device provided by the invention is characterized by arranging an element with equivalent resistance on a circuit board or a heat sink to detect the change of resistance value so as to determine temperature change. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell with temperature sensor device formed by disposing a membrane electrode assembly on a circuit board, characterized in which:
the circuit board comprises a temperature sensor module, the temperature sensor module having resistance property and being made of conductive line disposed on said circuit board, the conductive line having a characteristic of an equivalent resistor.

2. The fuel cell with temperature sensor device according to claim 1, wherein the circuit board further comprises a connector, the connector being electrically connected to the conductive line of said temperature sensor module.

3. The fuel cell with temperature sensor device according to claim 2, further comprising a heat sink, the heat sink being electrically connected to the connector.

4. The fuel cell with temperature sensor device according to claim 1, further comprising a heat sink, the heat sink being electrically connected to the conductive line of said temperature sensor module.

5. The fuel cell with temperature sensor device according to claim 1, further comprising a plurality of circuit boards and a plurality of membrane electrode assemblies, the membrane electrode assemblies being respectively disposed on the corresponding circuit board.

6. The fuel cell with temperature sensor device according to claim 5, further comprising a heat sink.

7. The fuel cell with temperature sensor device according to claim 6, wherein the heat sink is a fan and electrically connected to said conductive line where the conductive line controls the turning speed of the fan.

8. The fuel cell with temperature sensor device according to claim 1, wherein the conductive line can be replaced to serve as a high-resistance circuit.

9. A fuel cell with temperature sensor device formed by disposing a membrane electrode assembly on a circuit board and further formed into a power generation structure with a plurality of circuit boards, characterized in which:
an airflow path is formed between the circuit boards, the airflow path being disposed with a temperature sensor module, the temperature sensor module being conductive line with resistance property and electrically connected to the circuit board.

10. The fuel cell with temperature sensor device according to claim 9, wherein the circuit board further comprises a connector, the connector being electrically connected to the temperature sensor module.

11. The fuel cell with temperature sensor device according to claim 10, wherein the temperature sensor module is disposed on the circuit board and made of conductive line on the circuit board.

12. The fuel cell with temperature sensor device according to claim 10, wherein a heat sink can be installed in the airflow path.

13. The fuel cell with temperature sensor device according to claim 12, wherein the temperature sensor module is disposed on the heat sink.

14. The fuel cell with temperature sensor device according to claim 13, wherein the heat sink is a fan and electrically connected to said conductive line where the conductive line controls the turning speed of the fan.
